(19) United States
(12) Patent Application Publication
(10) Pub. No.: US 2023/0207828 A1
(43) Pub. Date: Jun. 29, 2023

(54) LITHIUM DEPOSITION-TYPE ALL-SOLID-STATE BATTERY WITH HIGH DURABILITY

(71) Applicants: Hyundai Motor Company, Seoul (KR); Kia Corporation, Seoul (KR)

(72) Inventors: Jae Min Lim, Suwon (KR); Hong Suk Choi, Hwaseong (KR); Sung Man Cho, Gwacheon (KR); Seon Hwa Kim, Cheongju (KR); Young Jin Nam, Suwon (KR); Sang Wan Kim, Anyang (KR)

(21) Appl. No.: 17/990,676

(22) Filed: Nov. 19, 2022

(30) Foreign Application Priority Data
Dec. 23, 2021 (KR) 10-2021-0185919

(51) Int. Cl. H01M 4/62; H01M 10/0525; H01M 4/38; H01M 4/587

(52) U.S. Cl. CPC H01M 4/628; H01M 10/0525; H01M 4/382; H01M 4/386; H01M 4/387; H01M 4/38; H01M 4/587; H01M 2220/20; H01M 2004/027

(57) ABSTRACT

Disclosed is an all-solid-state battery having a uniformly deposited or grown lithium layer, thereby having excellent durability.

### CROSS REFERENCE TO RELATED APPLICATION

The present application claims priority to Korean Patent Application No. 10-2021-0185919, filed Dec. 23, 2021, the entire contents of which is incorporated herein for all purposes by this reference.

### TECHNICAL FIELD

The present disclosure relates to an all-solid-state battery having uniformly deposited or grown lithium layer, thereby having excellent durability.

### BACKGROUND

The all-solid-state battery includes a three-layer laminate including a cathode layer bonded to a cathode current collector, an anode layer bonded to an anode current collector, and a solid electrolyte layer interposed between the cathode layer and the anode layer. In general, in an anode layer of an all-solid-state battery, an active material such as graphite and a solid electrolyte are combined. The solid electrolyte contributes to the movement of lithium ions in the anode layer. Due to the fact that the solid electrolyte has a greater specific gravity than the electrolyte of a lithium-ion battery and the ratio of the active material in the anode layer is reduced due to the presence of the solid electrolyte there, the actual energy density of the all-solid-state battery is lower than that of the lithium-ion battery.

In the related art, a research has been conducted to apply lithium metal to a cathode layer to increase the energy density of an all-solid-state battery. However, all-solid-state batteries using lithium may have technical difficulties in interfacial bonding and growth of lithium dendrites and market-related problems such as price and demand for large-scale batteries.

Further, in the related art, a research also have been conducted on anode-free all-solid-state batteries that includes no anode layer but lithium ions that are required to move to an anode current collector during charging are directly deposited on the anode current collector. However, the anode-free all-solid-state battery may also have problems in that it is difficult to uniformly deposit lithium, and non-uniformly deposited lithium increases an irreversible reaction, resulting in deterioration in durability.

### SUMMARY

In preferred aspects, provided is an all-solid-state battery in which lithium is uniformly deposited, there by having good durability.

Objectives of the present disclosure are not limited to the objective mentioned above. Other objectives of the present disclosure will become more apparent from the following description and will be realized by means and combinations thereof recited in the claims.

A term “all-solid-state battery” as used herein refers to a rechargeable secondary battery that includes an electrolyte in a solid state, e.g., gel or polymer (cured), which may include an ionomer and other electrolytic components for transferring ions between the electrodes of the battery. In certain aspect, the all-solid-state battery may be an anodeless all-solid-state battery or an anode-free lithium ion battery. Such batteries may include a current collector including anode active material, which may be bonded, coated, attached, sprayed, painted or applied on the surface of the current collector. Preferably, the anode active material is coated on the surface of the current collector and formed as a layer or film.

In an aspect, provided is an all-solid-state battery that includes an anode current collector, a solid electrolyte layer disposed on the anode current collector, and a cathode layer disposed on the solid electrolyte layer. The battery may be formed to have a planar surface with an area-to-circumference ratio of about 0.7 or less.

A term “planar surface” as used herein refers to a two-dimensional shape of a surface, in which if any two points are chosen, a straight line joining them lies wholly in that surface. The planar surface can be defined with parameters such as a width or a length of the planar surface if it is in a rectangular shape, or such as an area or circumference if it has regular or irregular shape.

The all-solid-state battery may further include a functional layer interposed between the anode current collector and the solid electrolyte layer, and the functional layer includes a carbon material.

The functional layer may include a metal powder including one or more metals selected from the group consisting of a combination of gold (Au), platinum (Pt), palladium (Pd), silicon (Si), silver (Ag), aluminum (Al), bismuth (Bi), tin (Sn), and zinc (Zn).

The all-solid-state battery may further include an anode layer positioned between the anode current collector and the solid electrolyte layer, and the anode layer may contain lithium.

The battery may include a reaction portion that may be formed to have a planar surface with an area-to-circumference ratio (P/A) of about 0.7 or less.

The term “reaction portion” as used herein refers to a portion of the battery where chemical reaction occurs for generating electrical energy, e.g., producing electrons. The reaction portion may include a portion of the stack where the anode current collector, the solid electrolyte layer and the cathode layer are disposed at least in part thereof or entirely stack. The reaction portion may also refer to a battery portion including the stack where the anode current collector, the solid electrolyte layer and the cathode layer are disposed but does not include edge part, exterior or trim made for package of the battery.

The planar surface of the battery may have a rectangular shape. The planar surface of the reaction portion may have a rectangular shape.

The area of the planar surface of the reaction portion may be about 40 to 200 cm².

The functional layer may have a thickness of about 30 μm or less.

The solid electrolyte layer may have a thickness of about 50 μm or less.

The all-solid-state battery may have a current density of about 0.01 mAh/cm² to 6.5 mAh/cm² during charging.

In another aspect, provided is a vehicle including the all-solid-state battery as described herein.

According to various exemplary embodiments of the present disclosure, since lithium can be uniformly deposited, an all-solid-state battery having excellent durability can be obtained.

Other aspects of the invention are disclosed infra.

### BRIEF DESCRIPTION OF THE DRAWINGS

FIG. 1 shows an exemplary all-solid-state battery according to an exemplary embodiment of the present disclosure;

FIG. 2 shows a charged state of an exemplary all-solid-state battery of FIG. 1 according to an exemplary embodiment of the present disclosure;

FIG. 3 shows an exemplary all-solid-state battery according to an exemplary embodiment of the present disclosure;

FIG. 4 shows a top plan view of the all-solid-state battery of FIG. 1;

FIGS. 5A to 5D show photographic images of the charged all-solid-state batteries according to Comparative Examples 1 to 4, respectively;

FIGS. 6A to 6D show photographic images of the charged all-solid-state batteries according to Examples 1 to 4, respectively.

### DETAILED DESCRIPTION

The above objectives, other objectives, features and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

In describing each figure, reference numerals like each other have been used for like elements. In the accompanying drawings, the dimensions of the structures are enlarged than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In the present specification, it should be understood that the term “including” or “have” is intended to specify that features, numbers, steps, operations, components, parts, or a combination of them described in the specification, and does not preclude the presence or addition of one or more other features, numbers, steps, operations, elements, or combinations thereof. Also, when a part of a layer, film, region, plate, etc., is said to be “on” another part, this includes not only the case where it is “on” another part but also the case where there is another part in between. Conversely, when a part such as a layer, film, region, plate, etc. is said to be “directly below” the other part, this includes not only the case where the other part is “directly below”, but also the case where there is another part between them.

Unless otherwise specified, all numbers, values, and/or expressions expressing quantities of ingredients, reaction conditions, polymer compositions, and formulations used herein contain all numbers, values, and/or expressions in which such numbers essentially occur in obtaining such values, among others. Since they are approximations reflecting various uncertainties in the measurement, it should be understood as being modified by the term “about” in all cases. Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Also, where the present disclosure discloses numerical ranges, such ranges are continuous and inclusive of all values from the minimum to the maximum inclusive of the range, unless otherwise indicated.

Furthermore, when such ranges refer to integers, all integers inclusive from the minimum to the maximum inclusive are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

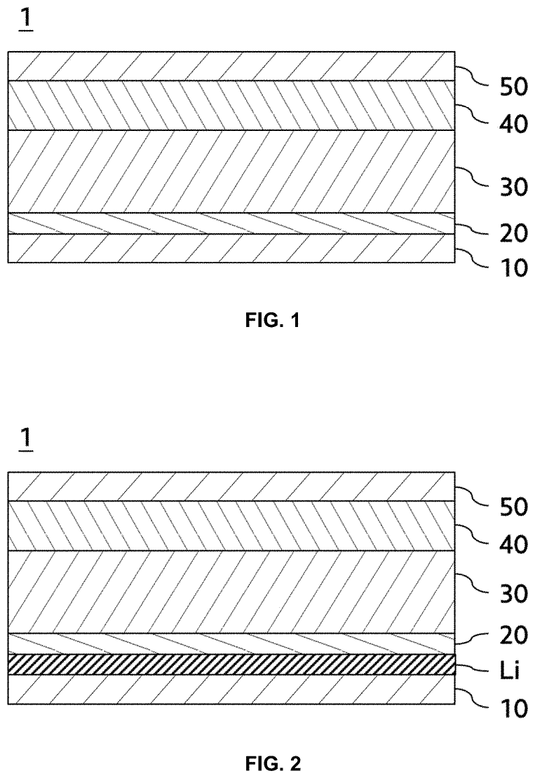

FIG. 1 shows an exemplary all-solid-state battery 1 according to an exemplary embodiment of the present disclosure. The all-solid-state battery 1 may have an anode current collector 10, a functional layer 20, a solid electrolyte layer 30, a cathode layer 40, and a cathode current collector 50 are stacked.

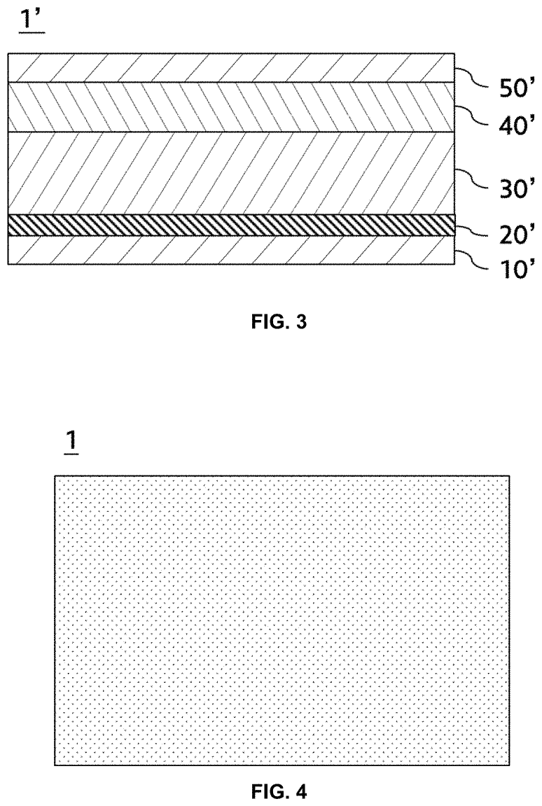

FIG. 2 shows a state in which the all-solid-state battery 1 is charged. When the all-solid-state battery 1 is charged, lithium metal (Li) may be deposited and stored between the functional layer 20 and the upper anode current collector 10.

Hereinafter, each configuration of the all-solid-state battery 1 will be described in detail.

Anode Current Collector

The anode current collector 10 may be an electrically conductive plate-shaped substrate. Specifically, the anode current collector 10 may be in the form of a sheet or a thin film.

The anode current collector 10 may include a material that does not react with lithium. Specifically, the anode current collector 10 may include at least one selected from the group consisting of nickel, stainless steel, titanium, cobalt, iron, and combinations thereof.

Functional Layer

The functional layer 20 is positioned between the anode current collector 10 and the solid electrolyte layer 30 to prevent the lithium metal (Li) deposited and stored on the anode current collector 10 from physically contacting the solid electrolyte layer 30 during charging.

In addition, the functional layer 20 may facilitate the movement of lithium ions moving through the solid electrolyte layer 30 so that the lithium ions are deposited on the anode current collector 10.

The functional layer 20 may include an electrically conductive carbon material. For example, the carbon material may include amorphous carbon: carbon black such as acetylene black, furnace black, and Ketjen black; and graphene.

The functional layer 20 may further include a metal powder capable of forming an alloy with lithium. The metal powder may include at least one selected from the group consisting of gold (Au), platinum (Pt), palladium (Pd), silicon (Si), silver (Ag), aluminum (Al), bismuth (Bi), tin (Sn), zinc (Zn), and a combination thereof.

The functional layer 20 may further include a binder. The binder may impart adhesion to the amorphous carbon, metal powder, and the like. The binder may be a butadiene rubber(BR), nitrile butadiene rubber(NBR), hydrogenated nitrile butadiene rubber(HNBR), polyvinylidene difluoride(PVDF), polytetrafluoroethylene(PTFE), and carboxymethylcellulose(CMC).

The functional layer 20 may include an amount of about 50 to 70 wt % of the carbon material, an amount of about 20 to 40 wt % of the metal powder, and an amount of about 1 to 10 wt % of the binder based on the total weight of the functional layer.

Solid Electrolyte Layer

The solid electrolyte layer 30 is positioned between the cathode layer 40 and the anode current collector 10 and is in charge of the movement of lithium ions.

The solid electrolyte layer 30 may include a solid electrolyte having lithium-ion conductivity.

The solid electrolyte may be an oxide-based solid electrolyte or a sulfide-based solid electrolyte. However, it may be preferable to use a sulfide-based solid electrolyte having high lithium-ion conductivity. The sulfide-based solid electrolyte is not particularly limited, but Li₂S—P₂S₅, Li₂S—P₂S₅—LiI, Li₂S—P₂S₅—LiCl, Li₂S—_{P2}S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where m, n is a positive number, Z is one of Ge, Zn, Ga), Li₂S—GeS₂, Li₂S—SiS₂—Li₃PO₄, Li₂S—SiS₂-LiₓMO_{y} (where x and y are positive numbers, M is one of P, Si, Ge, B, Al, Ga, In), Li₁₀GeP₂S₁₂, and the like.

The solid electrolyte layer 30 may further include a binder. The binder may suitably include a butadiene rubber (BR), nitrile butadiene rubber (NBR), hydrogenated nitrile butadiene rubber(HNBR), polyvinylidene difluoride (PVDF), polytetrafluoroethylene (PTFE), and carboxymethylcellulose (CMC).

Cathode Layer

The cathode layer 40 is configured to reversibly occlude and release lithium ions. The cathode layer 40 may include a cathode active material, a solid electrolyte, a conductive material, a binder, and the like.

The cathode active material may be an oxide active material or a sulfide active material.

The oxide active material may be a Sabkha type active material such as LiCoO₂, LiMnO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, and a reverse spinel such as LiNiVO₄ and LiCoVO₄ type active material, an olivine type active material such as LiFePO₄, LiMnPO₄, LiCoPO₄, LiNiPO₄, a silicon-containing active material such as Li₂FeSiO₄, Li₂MnSiO₄, a Sabkha type active material in which a part of the transition metal is substituted with a dissimilar metal, such as LiNi_{0.8}Co_{(0.2-x)}AlₓO₂(0<x<0.2), a spinel-type active material in which a part of the transition metal is substituted with a different metal, such as Li₁₊ₓMn_{2-x-y}M_{y}O₄ (where M is at least one of Al, Mg, Co, Fe, Ni, and Zn, and may be 0<x+y<2), or lithium titanate such as Li₄Ti₅O₁₂.

The sulfide active material may be copper Chevrel, iron sulfide, cobalt sulfide, nickel sulfide, and the like.

The solid electrolyte may be an oxide-based solid electrolyte or a sulfide-based solid electrolyte. However, it may be preferable to use a sulfide-based solid electrolyte having high lithium-ion conductivity. The sulfide-based solid electrolyte is not particularly limited, but Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—Si₂, Li₂S—Si₂—LiI, Li₂S—Si₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where m, n is a positive number, Z is one of Ge, Zn, Ga), Li₂S—GeS₂, Li₂S—Si₂—Li₃PO₄, Li₂S—Si₂-LiₓMO_{y} (where x and y are positive numbers, M is one of P, Si, Ge, B, Al, Ga, In), Li₁₀GeP₂S₁₂, and the like.

The conductive material may be carbon black, conductive graphite, ethylene black, graphene, and the like.

The binder may suitably include a butadiene rubber (BR), nitrile butadiene rubber (NBR), hydrogenated nitrile butadiene rubber (HNBR), polyvinylidene difluoride (PVDF), polytetrafluoroethylene (PTFE), and carboxymethylcellulose (CMC).

Cathode Current Collector

The cathode current collector 50 may be an electrically conductive plate-shaped material. For example, the cathode current collector 50 may be in the form of a sheet or a thin film.

The cathode current collector 50 may include at least one selected from the group consisting of indium, copper, magnesium, aluminum, stainless steel, iron, and combinations thereof.

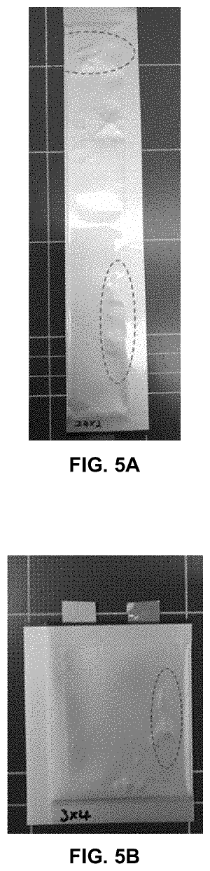

FIG. 3 shows a second embodiment of the all-solid-state battery 1′ according to the present disclosure. The all-solid-state battery 1′ may be a laminate of an anode current collector 10′, an anode layer 20′, a solid electrolyte layer 30′, a cathode layer 40′, and a cathode current collector 50′.

The anode layer 20′ may include lithium metal. Accordingly, when the all-solid-state battery 1′ is charged, lithium metal may be deposited and stored between the anode layer 20′ and the anode current collector 10′.

Other configurations are the same as those of the first embodiment described above and thus will be omitted.

All-solid-state batteries 1 and 1′ according to various exemplary embodiments of the present disclosure is characterized in that lithium ions can be uniformly deposited between the functional layer 20 and the anode current collector 10 or between the anode layer 20′ and the anode current collector 10′ by adjusting a ratio of area (A) to a circumference (P) of its planar surface.

Since the edge part of the battery forms an interface between the solid and the gas, the surface energy is greater than the inside of the battery with the interface between the solid and the solid. Accordingly, in the deposition-type batteries such as the all-solid-state batteries 1 and 1 ′, lithium ions move toward the edge part direction to stabilize thermodynamically high surface energy, and thus lithium metal is deposited at the edge part. Lithium metal deposited and grown at the edge part may cause a short circuit of the battery and may become inert lithium (dead lithium), which may adversely affect the performance of the battery.

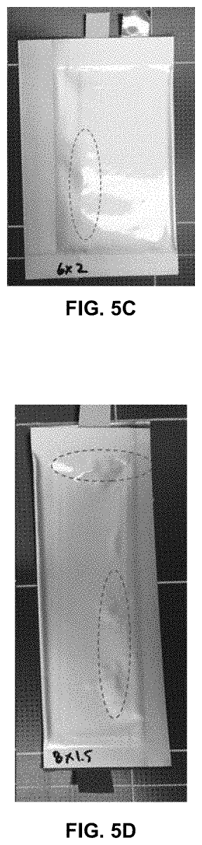

FIG. 4 is a top plan view of the all-solid-state battery 1, according to an exemplary embodiment of the present disclosure. FIG. 4 shows a top plan view of the reaction part of the all-solid-state battery 1. The reaction part refers to a space in which a substantial electrochemical reaction occurs in the all-solid-state battery 1 and refers to a part or a space in which all components of the anode current collector 10, the functional layer 20, the anode layer 20′, the solid electrolyte layer 30, and the cathode layer 40 are overlapped and laminated. For example, when the cathode layer 40 is formed less than the functional layer 20 or the anode layer 20′ and the solid electrolyte layer 30, the area (A) and the circumference (P) of the reaction part refer to the planar surface of the cathode layer 40 as a reference.

The present disclosure is characterized in that the ratio (P/A) of area (A) to the circumference (P) of the reaction part is adjusted to about 0.7 or less based on a planar surface in order to control the deposition and growth of abnormal lithium at the edge part of the all-solid-state battery 1. The circumference (P) is less than the area (A), and when area (A) is the same, and the circumference (P) is reduced, the surface energy at the interface between the solid and the gas at the edge part can be reduced, thereby suppressing lithium ions from moving to the edge side and depositing.

In addition, the planar surface of the all-solid-state battery 1 may have a rectangular shape. However, the shape of the planar surface is not limited thereto and may have a shape such as a circle or a polygon.

The area (A) of the planar surface may be about 40 cm² to 200 cm². When the area (A) of the planar surface is within the above range, and the ratio (P/A) of area (A) to the circumference (P) is satisfied, it is possible to suppress lithium from being abnormally deposited and grown at the edge part of the all-solid-state battery.

The movement and deposition rate of lithium ions in the all-solid-state battery 1 may be affected by the thickness of the functional layer 20 or the anode layer 20′ and the thickness of the solid electrolyte layer 30. In the all-solid-state battery, according to the present disclosure, the thickness of the functional layer 20 or the anode layer 20′ may be 30 μm or less, and the thickness of the solid electrolyte layer 30 may be about 50 μm or less. The lower limit of the thickness of the functional layer 20 or the anode layer 20′ is not particularly limited and may be, for example, about 5 μm or greater, or 10 μm or greater, or 15 μm or greater. In addition, the lower limit of the thickness of the solid electrolyte layer 30 is not particularly limited and may be, for example, 5 μm or greater, or 10 μm or greater, or 15 μm or greater.

On the other hand, the deposition behavior of lithium may be affected by the current density. The all-solid-state battery, according to the present disclosure, may have a current density of about 0.01 mAh/cm² to 6.5 mAh/cm² during charging.

### EXAMPLE

Hereinafter, another embodiment of the present disclosure will be described in more detail through examples. The following examples are only examples to help understanding of the present disclosure, and the scope of the present disclosure is not limited thereto.

### Examples 1 to 4 and Comparative Examples 1 to 4

As shown in FIG. 1, an all-solid-state battery in which an anode current collector, a functional layer, a solid electrolyte layer, a cathode layer, and a cathode current collector were laminated was prepared. The thickness of the functional layer was about 15 μm, and the thickness of the solid electrolyte layer was about 30 μm. Table 1 below shows the area (A) and the circumference (P), the ratio of the long side to the short side constituting the circumference, and the ratio (P/A) of area (A) to the circumference (P) of each all-solid-state battery.

TABLE 1

| | Area | Circumference | Ratio of the short | |
|---|---|---|---|---|
| Division | [cm]²] | [cm] | side and long side | P/A |
| Example 1 | 192 | 56 | 3 × 4 | 0.292 |
| Example 2 | 192 | 64 | 1 × 4 | 0.333 |
| Example 3 | 48 | 28 | 3 × 4 | 0.583 |
| Example 4 | 48 | 32 | 1 × 3 | 0.667 |
| Comparative | 48 | 52 | 1 × 12 | 1.083 |
| Example 1 | | | | |
| Comparative | 12 | 14 | 3 × 4 | 1.167 |
| Example 2 | | | | |
| Comparative | 12 | 16 | 1 × 3 | 1.333 |
| Example 3 | | | | |
| Comparative | 12 | 19 | 1.5 × 8 | 1.583 |
| Example 4 | | | | |

Each all-solid-state battery was charged to allow lithium metal to be deposited and grow. At this time, the current density was adjusted to 5.0 mAh/cm².

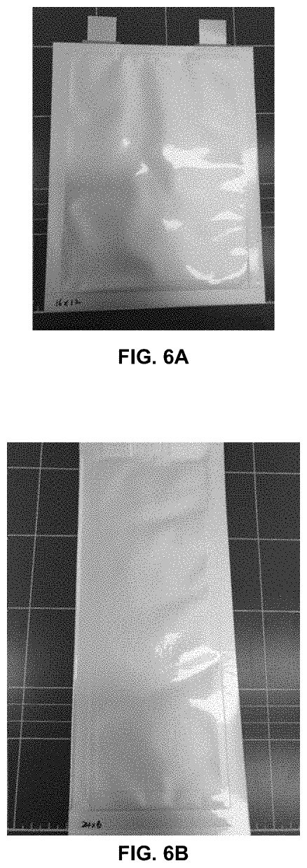

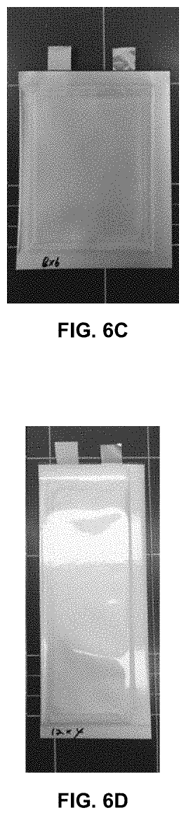

FIGS. 5A to 5D are results of charging the all-solid-state batteries according to Comparative Examples 1 to 4, respectively. FIGS. 6A to 6D are results of charging the all-solid-state batteries according to Examples 1 to 4, respectively.

As shown in FIGS. 5A to 5D, the all-solid-state batteries, according to Comparative Examples 1 to 4, lithium was abnormally deposited and grown at the edge part. On the other hand, as shown in FIGS. 6A to 6D, in the all-solid-state batteries, according to Examples 1 to 4, there was no specific lithium deposition and growth at the edge part, unlike the comparative examples above.

As the experimental examples and examples of the present disclosure have been described in detail above, the scope of the present disclosure is not limited to the above-described experimental examples and examples, and the basic concept of the present disclosure is defined in the following claims. Various modifications and improved forms used by those skilled in the art are also included in the scope of the present disclosure.

What is claimed is:

1. An all-solid-state battery comprising:
an anode current collector;
a solid electrolyte layer disposed on the anode current collector; and
a cathode layer disposed on the solid electrolyte layer,
wherein the battery is formed to have a planar surface with an area-to-circumference ratio of about 0.7 or less.

2. The all-solid-state battery of claim 1, wherein the all-solid-state battery further comprises a functional layer disposed between the anode current collector and the solid electrolyte layer, and the functional layer comprises a carbon material.

3. The all-solid-state battery of claim 2, wherein the functional layer further comprises a metal powder comprising one or more metal components selected from the group consisting of gold (Au), platinum (Pt), palladium (Pd), silicon (Si), silver (Ag), aluminum (Al), bismuth (Bi), tin (Sn), and zinc (Zn).

4. The all-solid-state battery of claim 1, wherein the all-solid-state battery further comprises an anode layer disposed between the anode current collector and the solid electrolyte layer, and the anode layer comprises lithium metal.

5. The all-solid-state battery of claim 1, wherein reaction portion of the battery is formed to have a planar surface with an area-to-circumference ratio of about 0.7 or less.

6. The all-solid-state battery of claim 1, wherein the planar surface of the battery has a rectangular shape.

7. The all-solid-state battery of claim 1, wherein the area of the planar surface is about 40 cm² to 200 cm².

8. The all-solid-state battery of claim 2, wherein the functional layer has a thickness of about 30 μm or less.

9. The all-solid-state battery of claim 1, wherein the solid electrolyte layer has a thickness of about 50 μm or less.

10. The all-solid-state battery of claim 1, wherein the battery has a current density of about 0.01 mAh/cm² to 6.5 mAh/cm² during charging.

11. A vehicle comprising an all-solid state battery of claim 1.
